(19) United States
(12) Patent Application Publication
(10) Pub. No.: US 2009/0037487 A1
(43) Pub. Date: Feb. 5, 2009

(54) PRIORITIZING DOCUMENTS

(76) Inventor: David P. Fan, St. Paul, MN (US)

Correspondence Address: SCHWEGMAN, LUNDBERG & WOESSNER, P.A., P.O. BOX 2938, MINNEAPOLIS, MN, 55402, US

(21) Appl. No.: 12/180,891

(22) Filed: Jul. 28, 2008

Related U.S. Application Data
(60) Provisional application No. 60/962,162, filed on Jul. 27, 2007.
(60) Provisional application No. 61/000,988, filed on Oct. 30, 2007.

(51) Int. Cl. G06F 17/30

(52) U.S. Cl. 707/200; 707/E17.01

(57) ABSTRACT

Systems, methods, and structures are described to support the enhanced text analysis of documents. Various embodiments include a text analysis system in which documents are prioritized by combinations of keywords in the texts of paragraphs of a document. The system and methods disclosed are useful for exploring documents using a plurality of keywords.

### PRIORITY APPLICATIONS

This patent application claims the benefit of priority, under 35 U.S.C. Section 119(e), to U.S. Provisional Patent Application Ser. No. 60/962,162, filed on Jul. 27, 2007, and to U.S. Provisional Patent Application Ser. No. 61/000,988, filed on Oct. 30, 2007, which applications are incorporated herein by reference in their entirety.

### TECHNICAL FIELD

The technical field relates generally to the analysis of documents including text. More particularly, the field pertains to the prioritization of documents based on their texts.

### COPYRIGHT NOTICE—PERMISSION

A portion of the disclosure of this patent document includes material which is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawings attached hereto: Copyright© 2008, David P. Fan, All Rights Reserved.

### BACKGROUND

In current methods, documents including text can be held in an electronic database. Methods have been developed for searching the database to retrieve a document set that is especially relevant to a topic area. A human user may desire to focus on documents including a plurality of ideas in the topic area.

### SUMMARY

Systems, methods, and structures are discussed to support a text analysis for the prioritization of documents in a document set. According to one embodiment the documents include texts divided into paragraphs. The system may include a document set, communication means that allows access to the documents, and a text analysis engine for generating a prioritized order for a document set.

### BRIEF DESCRIPTION OF THE DRAWINGS

FIG. 1 is a block diagram of a system according to embodiments of the invention.

FIG. 2 is a structure diagram of a structure according to embodiments of the invention.

FIG. 3 is a structure diagram of an example structure according to embodiments of the invention.

FIG. 4 is a structure diagram of an example structure according to embodiments of the invention.

FIGS. 5-7 are table representations of example tables according to embodiments of the invention.

FIG. 8 is a process diagram of a method according to embodiments of the invention.

FIG. 9 is a process diagram of a method according to according to embodiments of the invention.

FIG. 10 is a process diagram of a method according to embodiments of the invention.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

One embodiment of the present invention includes a text analysis system for analyzing a document set and outputting a prioritized document order. The prioritized order may be based on a number of factors, including, but not limited to, a plurality of keywords and user defined criteria.

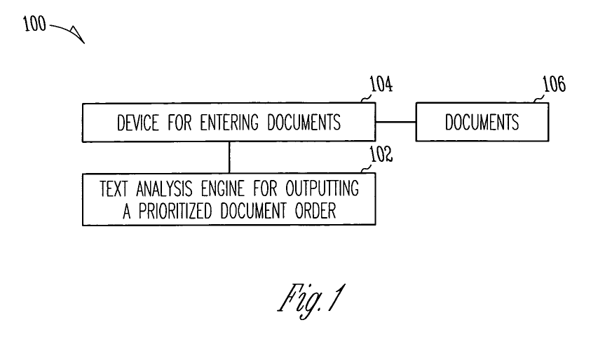

FIG. 1 is a block diagram of a system 100 according to an embodiment of the present invention. The system 100 includes a text analysis engine 102. The text analysis engine 102 may include software for outputting a prioritized document order. In one embodiment, the text analysis engine 102 is adapted to interface with a device 104 for entering documents 106. In an embodiment the text analysis engine may output a prioritized order of paragraphs or sentences or any combination of documents, paragraphs, or sentences.

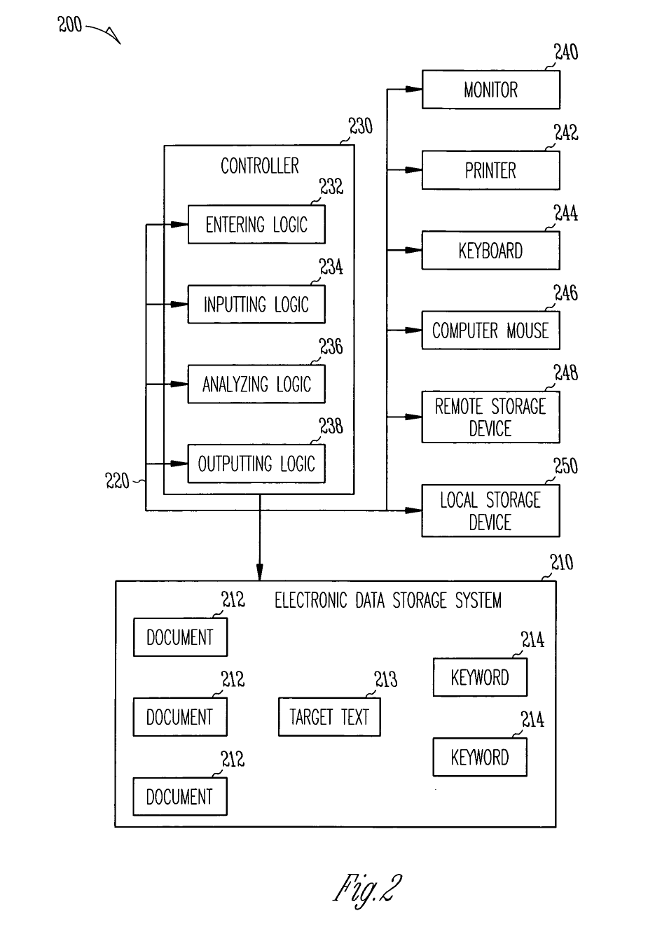

FIG. 2 illustrates an example system 200. The system 200 may include an electronic data storage system 210. Document 212, target text 213, and keyword 214 may be stored in the electronic data storage system 210. In an embodiment there may be more than one document 212 and keyword 214 stored in the electronic data storage system 210. A controller 230 may be communicatively coupled 220 to the electronic data storage system 210. The controller 230 may include entering logic 232, inputting logic 234, analyzing logic 236 and outputting logic 238. The system may also include a monitor 240, a printer 242, a keyboard 244, a computer mouse 246, a remote storage device 248, and a local storage device 250.

In an embodiment, document 212 includes text that includes at least one paragraph. Each paragraph may include one or more sentences that have a sentence-terminating punctuation mark. For example, the sentence-terminating punctuation mark may be a period, question mark, or an exclamation point. In one embodiment the sentence-terminating punctuation mark is preceded by a word that is at least three characters in length.

In another embodiment, a text search method is used to search for an idea in the text. In one embodiment, the text search method is to search for a keyword 214. A keyword 214 may include a word stem. A word stem may include the initial characters of a word. As an example, a word stem “metal” matches the initial five characters of each of the words “metal,” “metals,” and “metallic.” In one embodiment, a word stem is a complete word. As an example, a word stem may be the complete word “the” with no trailing characters permitted. In a further embodiment, the text search method may be a Boolean search method where the search condition may be a match to the condition “(buy and (paper or clip)).” In one embodiment, a text search method may be a match to a regular expression such as “buy|metal*.” In one embodiment, the text search condition may be a fuzzy logic search method. For the Boolean, regular expression, and fuzzy logic search methods the resultant matches may be considered keywords that may then be entered into the system.

In an embodiment, controller 230 may include control logic to control a text analysis process. The control may include an entering logic 232 to control the task of entering documents (e.g., document 212) into the electronic data storage system 210. Inputting logic 234 may be used to control the task of inputting user-specific conditions for text analysis. Analyzing logic 236 may control the text analysis. Outputting logic 238 may control the output of the text analysis.

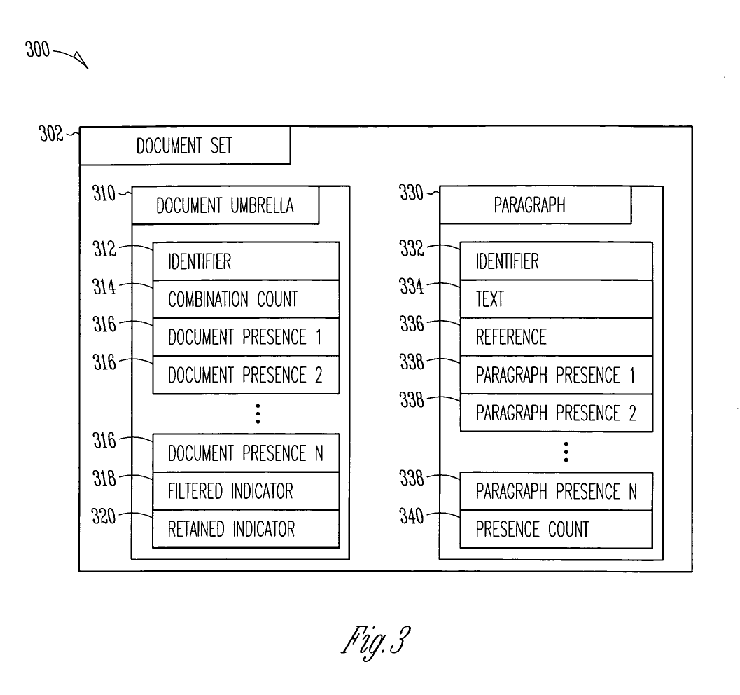

FIG. 3 is a structure diagram 300 of an example document set 302. Document set 302 may include many data members including one or more document umbrellas 310 and paragraphs 330. In an embodiment, a document set 302 represents information used for outputting a prioritized document, paragraph, or sentence order.

In an example embodiment, document set 302 includes at least one document umbrella 310. Document umbrella 310 may include representations of an entire document. Document umbrella 310 may also include data members such as a document identifier 312, a combination count 314, one or more documents presences 316, a filtered indicator 318, and a retained indicator 320. Document set 302 may also include at least one paragraph 330. Paragraph 330 may include data members such as a paragraph identifier 332, text 334, reference 336, one or more paragraph presences 338 and a presence count 340.

In an embodiment, document identifier 312 uniquely identifies a document. This may for example be a randomly generated number. It may also be the next available number in a sequence. The data member combination count 314 represents the combination count of a document. A combination count 314 may represent the number of distinct combinations of paragraph presences 338 associated with a document. Data members document presences 316 may represent the extent to which a keyword is present in a document. The filtered indicator 318 data member may represent the selection of a document based on a filter keyword. In an example embodiment, retained indicator 320 represents the retention of a document based on a threshold combination count that may be set by a user.

In an embodiment, data member paragraph identifier 332 uniquely identifies a paragraph 330. Data member text 334 may represent the text of a paragraph 330. In one embodiment data member reference 336 represents the document to which a paragraph belongs. For instance, reference 336 may be the same as a document identifier 312. Data members paragraph presences 338 may represent the presence of the word stem of a keyword in the text of a paragraph. In an embodiment, data member presence count 340 represents the count of presences 338 with non-zero values for a paragraph.

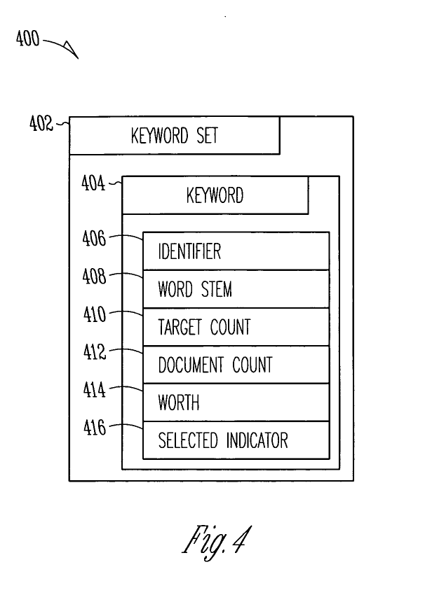

FIG. 4 is a structure diagram 400 of an example keyword set 402. Keyword set 402 may include one or more keywords 404. Each keyword 404 may include many data members such as a keyword identifier 406, a word stem 408, a target count 410, a document count 412, a worth 414, and a selected indicator 416.

In an embodiment, a keyword identifier 406 uniquely identifies a keyword 404. Data member word stem 408 may represent a word stem of a keyword 404. Data member target count 410 may represent the number of instances of the word stem 408 of a keyword 404 in a user specified target text. Data member document count 412 may represent the number of documents (e.g., data member 310) with the word stem 408 of a keyword 404. Data member worth 414 may represent the worth of a keyword 404. In an example embodiment, worth 414 may be the equivalent of target count 410 divided by document count 412, if the document count 412 is non-zero. Data member selected indicator 416 may represent whether or not the keyword 404 has been selected. For instance, a user may indicate that only the four highest worth keywords should be selected. If a keyword is in the top four of worth levels, then the selected indicator 416 may be set to a value indicating the keyword is selected (e.g., ‘1’).

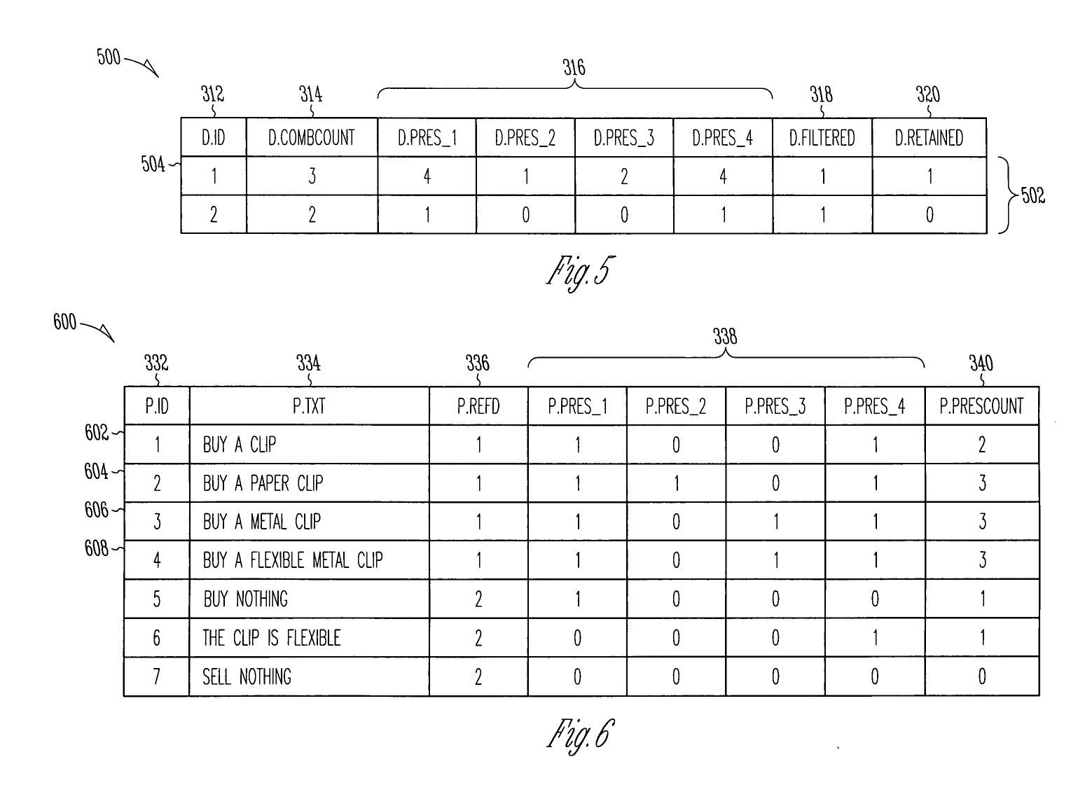

FIGS. 5-7 represent example table representations of data that may be stored in data structures such as those illustrated in FIGS. 3-4.

FIG. 5 represents an example set of documents. Document umbrellas 310 of the example document set 502 are represented according to FIG. 5 as a table representation 500 wherein the rows represent the document umbrellas 310 and the columns represent document umbrella data members. In the example shown, there is one document umbrella 310 for each of the two documents in the document set 502 with: values for document identifier 312 in column D.ID, values for combination count 314 in column D.CombCount, values for document presences 316 in columns D.Pres_n with n=1 to 4, values for filtered indicator 318 in column D.Filtered, and values for retained indicator 320 in column D.Retained.

FIG. 6 represents an example collection of paragraphs (e.g., 330) of a document set. Multiple paragraphs are represented in a table representation 600 wherein the rows represent paragraphs and the columns represent paragraph data members. In the example table representation 600, there are seven paragraphs for two documents in the document set with: example values for paragraph identifier 332 in column P.ID, values for text 334 in column P.Txt, values for reference 336 in column P.RefD, values for one or more paragraph presences 338 in columns P.Pres_n with n=1 to 4, and values for presence count 340 in column P.PresCount.

FIG. 7 represents an example of a keyword set in a table representation 700 wherein the rows represent keywords (e.g., 404) and the columns represent keyword data members. In the example shown, there are five keywords with example values: values for keyword identifier 406 in column K.ID, values for word stem 408 in column K.WordStem, values for target count 410 in column K.TargetCount, values for document count 412 in column K.DocumentCount, values for worth 414 in column K.Worth, and values for a selected indicator 416 in column K.Selected.

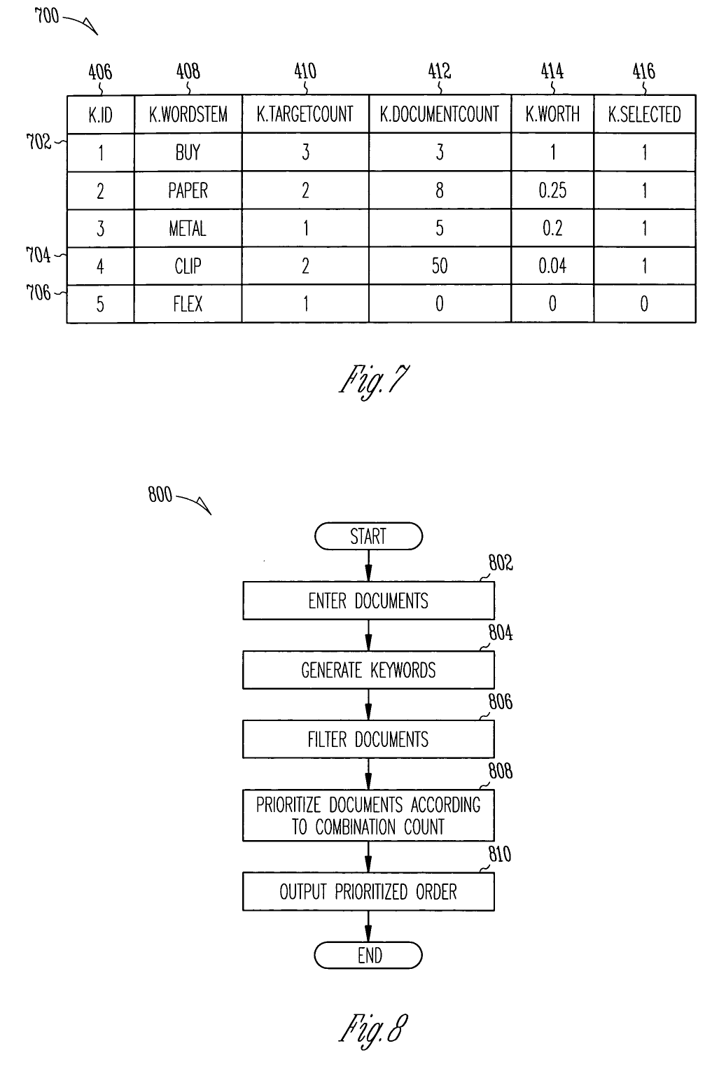

FIG. 8 depicts a flowchart 800 describing an example method to prioritize documents. At block 802, a plurality of documents is entered into the system. This may include entering the documents into an electronic data storage system. The electronic data storage system may include representations of the documents in the form of data structures such as 310 and 330 as described in FIG. 3. The entering process may include giving each document a document identifier 312. The process may also include giving each paragraph in a document a paragraph identifier 332, text 334, and a reference 336. The entering may be done by a user of the system or the process may be automated.

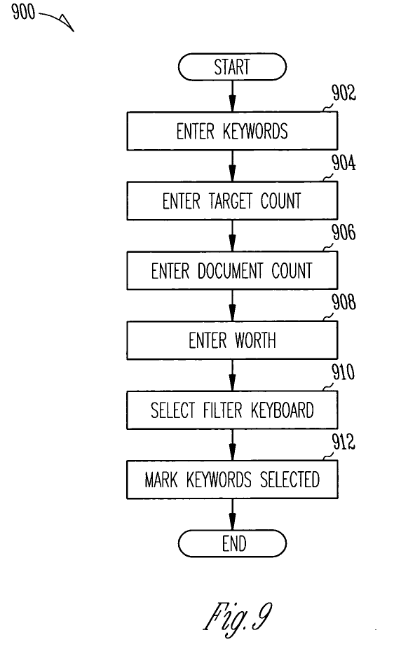

At block 804, in one embodiment, a plurality of keywords is generated from a target text. In an embodiment, there may be the generation of text analysis conditions from the target text. The target text may be a user selected set of words or paragraphs that the system uses to generate a set of keywords. The target text may be a representative paragraph that has many of the words or phrases that are important to the user in the eventual prioritization of a document set. This target text may, for example, be a patent claim. In one embodiment, the generation of text analysis conditions from the target text is omitted. In one embodiment, text analysis conditions are obtained through a process external to the processes of the present invention. In one embodiment, text analysis conditions are specified by a user. The conditions may include excluding one or more word stems from the plurality of keywords. The process of generating keywords is described in more detail below with reference to FIG. 9.

At block 806, in an embodiment, the documents are filtered according to a filter keyword. The filter keyword may be selected from the plurality of keywords, the selecting including comparing the target count of each keyword in the plurality of keywords to a filter count. In an embodiment, a document set is filtered to only include documents that include the filter keyword. The filter count may be based on a preference of the user of the system. The count may be a number that the user may use to limit the number of documents that are ultimately prioritized. An example is described more fully below with reference to block 910 and FIG. 9. In some embodiments block 806 may be skipped and no filter keyword may be selected or used.

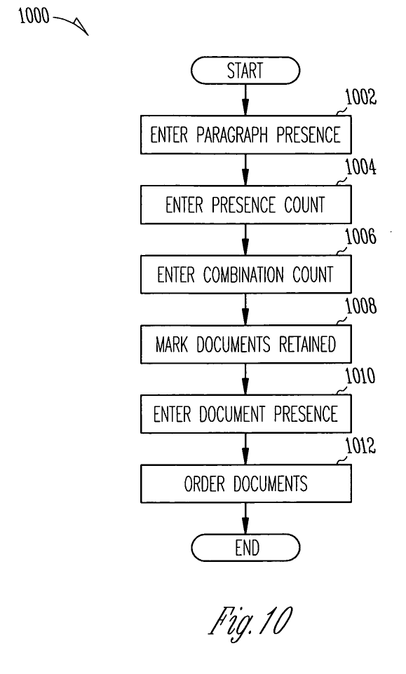

At block 808, the plurality of documents is prioritized into a prioritized document order according to combination counts. As described above, a combination count is the number of distinct combinations of paragraphs presences for a document. A user may also specify a threshold combination count such that no documents below the threshold combination count are prioritized. The process of prioritization is more fully described below with reference to FIG. 10.

At block 810 the prioritized document order is outputted. This output may be presented to a user in a variety of forms, including, but not limited to, a list of document identifiers or the full document text. In an embodiment, a prioritized paragraph order of paragraphs in the document set is ordered irrespective of the documents to which the paragraphs belong. In an embodiment the prioritized document order is displayed to a user through a web browser. In one embodiment, the paragraphs are ordered based on at least one paragraph member. In one embodiment, the paragraphs are ordered by paragraph presence count. Further details regarding the presentation of a prioritized output may be found U.S. patent application Ser. No. 11/275,947, entitled “POPULATION ANALYSIS USING LINEAR DISPLAYS”, filed on Feb. 6, 2006, the contents of which are hereby incorporated by reference for all purposes.

FIG. 9 is a flowchart 900 that details an example embodiment of generating keywords. At block 902, in an embodiment, a plurality of keywords are gathered from a target text and entered into the system. The user may first define a target text for the system to analyze. The user may also specify a set of exclusion word stems. As an example, an excluded word stem is the complete word “the.” The system may scan the target text for all distinct word stems not matching an exclusion word stem. Then, each of the non-excluded distinct word stems may be put into a data structure such as keyword 404 with each word stem given a keyword identifier. For example, referring to example entry 702 in FIG. 7, the word stem “buy” has been given a keyword identifier of ‘1’.

In one embodiment, at block 904, a target count 412 is entered for each keyword. The target count corresponds to the number of instances of the word stem 408 in the target text. Using example entry 702 again, a value of ‘3’ is entered for K.TargetCount for the word stem “buy” because the example target text has 3 instances of the word stem “buy.”

In an embodiment, at block 906, a document count 412 is entered for each keyword. This may include scanning the texts of all paragraphs of a document for the presence of at least one instance of a word stem of a keyword. The document count 412 may reflect the count of documents with at least one paragraph with at least one instance of the word stem. Looking at entry 704 in FIG. 7 there is a value of 50 for K.DocumentCount because 50 separate documents in the example document set have the word stem “clip” in the text of at least one paragraph.

In an embodiment, at block 908 a worth is entered for each keyword. A zero may be entered if a document count corresponding to the word stem is zero. If a document count is not zero, the worth value may be equivalent to the target count divided by the document count. Referring to example entry 702, the K.Worth value is equal to 1 because K.TargetCount and K.DocumentCount are the same (3/3=1). Example entry 704 shows a K.Worth of 0.04 (2/50) and example entry 706 has a K.Worth value of 0 because K.DocumentCount is 0.

In yet another embodiment, at block 910 a filter keyword is selected. The user may specify a desired filter count corresponding to the desired number of documents to be analyzed. A filter keyword may be the keyword with a document count closest to the user specified desired filter count. As an example, with reference to example table 700, a user may specify a desired filter count of 40. Entry 704 with K.ID=4 and K.WordStem=“clip” may be selected as the filter keyword because the K.DocumentCount=50 is the value in the column closest to the desired filter count of 40.

Once the filter keyword is selected, the filtered indicator 318 can be set as a ‘1’ or a ‘0.’ A ‘1’ may be entered if at least one paragraph of a document has at least one word stem matching the word stem of the filter keyword. Otherwise, a ‘0’ may be entered. For example, in FIG. 5, row 504 has a filtered indicator of ‘1’ indicating the word stem ‘clip’ must be present in at least one paragraph in the document. Looking at row 602 in FIG. 6 it can be seen that the word stem “clip” is present in the text “Buy a clip.” Those skilled in the art will appreciate that other values besides ‘1’ and ‘0’ may be used.

Referring back to FIG. 9, in an embodiment, at block 912, the keywords are marked selected. In an example embodiment, a user specifies a maximum number of selected keywords. The keyword set may then be sorted in order of decreasing worth 414 to give an ordered keyword set. A ‘1’ may be entered into the selected indicator 416 for keywords up to the specified number, starting from top of the ordered set. A ‘0’ may be entered into the selected indicator 416 for any other keywords in the set. Keywords with the value of 1 for selected indicator 416 are considered selected keywords. For example, a user may specify four as the maximum number of selected keywords. With reference to FIG. 7, a ‘1’ may be entered in to the top four rows of selected indicator 416 and a ‘0’ for the last row. Those skilled in the art will appreciate that other values besides ‘1’ and ‘0’ may be used.

FIG. 10 is a flowchart 1000 that details an example embodiment prioritizing documents. At block 1002 paragraph presences may be entered for each paragraph in a document set. In an example, a first document is retrieved from the document set that includes a plurality of paragraphs, and the plurality of paragraphs is analyzed to determine the paragraph presences. As discussed above, a paragraph presence may indicate the presence of at least one instance of a word stem of a selected keyword. The selected keywords may come from a process such as described in FIG. 9. In an embodiment, if there are n selected keywords there will n paragraph presences 338 for each paragraph. A value of one may be entered if the word stem of a selected keyword is present in a text of a paragraph and a value of zero if the word stem of a selected keyword is not present. A value of one may also be considered a positive paragraph presence and a value of zero may by considered a negative paragraph presence. Those skilled in the art will appreciate that other values besides ‘1’ and ‘0’ may be used. The index n of paragraph presences 338 may be the keyword identifier of a selected keyword in the keyword set 402.

Consider example table 600 and row 602 representing the paragraph with the text “Buy a clip.” The paragraph may be scanned for the presence of the word stem “buy” corresponding to the word stem “buy” in row 702 of table 700. Because “buy” is present, a ‘1’ may be entered into the paragraph presence indexed to the selected keyword buy, in this case P.Pres_{—}1. The process may be repeated iteratively for each of the selected keywords and for each of the paragraphs in the document set.

Referring back to FIG. 10, at 1004 a presence count is entered for each paragraph. In an embodiment, the presence count is the number of all paragraph presences with non-zero values. As an example, row 602 of table 600 has a presence count of two because there are two non-zero paragraph presence values.

At block 1006, a combination count is entered for each document. A combination count is the number of distinct combinations of paragraph presences 338 for all the paragraphs of a document wherein at least one paragraph presence 338 is non-zero. As an example, the document in example row 504 in table 500 is represented by rows example 602, 604, 606, and 608 in table 600. There are three distinct combinations of paragraph presences because example rows 606 and 608 have the same combination of paragraph presences 1, 3, and 4 in presence columns 338. Therefore a combination count value of three may be entered into row 504.

At block 1008, a retained indicator value is entered for each document. In an embodiment, a user may specify a minimum combination count. A value of one may be entered into the retained indicator data member when a filtered indicator has the value of one and at least one paragraph has at least one presence count greater than or equal to the minimum combination count. A value of zero may be entered for all other documents. As an example, a user may specify three to be the minimum combination count. Row 504 has a retained indicator 320 value of one because filtered indicator 318 has the value of one and at least one of the rows 602, 604, 606, and 608 belonging to document 504 has a presence count 340 greater than or equal to three. The three rows matching this condition are 604, 606, and 608.

At block 1010, document presences are entered for each document. In an embodiment, a document presence data member is computed from the paragraphs belonging to the document. The value of a document presence may be the sum of the corresponding paragraph presences for all paragraphs belonging to the document. As an example, consider example tables 500 and 600. Example row 504, representing document 1, has a value of four for document presence 1 (represented as D.Pres_{—}1) because the sum is four for the P.Pres_{—}1 values for the four rows, 602, 604, 606, and 608 which correspond to the paragraphs for document 1.

At block 1012, in an embodiment, the documents are ordered. This may include, as a prioritized document set, all documents with document umbrellas with retained indicator 320 values equal to ‘1’. The prioritized document set may be ordered hierarchically beginning with the combination count followed by each document presence n 316 with n ordered by worth 414. As an example, example table 500 in FIG. 5 is ordered by D.CombCount, followed by D.Pres_{—}1, followed by D.Pres_{—}2, followed by D.Pres_{—}3, followed by D.Pres_{—}4. The D.Pres_n has index n in the order 1, 2, 3, 4 because n=K.ID in table 700 and K.ID is ordered from K.ID=1 down to K.ID=4 when the rows are ordered by decreasing K.Worth. The documents with a non-zero retained indicator may be outputted as a prioritized document order.

In the example embodiments discussed above, various modifications can be made without departing from the scope of the inventive subject matter.

### CONCLUSION

Systems, methods, and structures have been discussed for prioritizing documents by combinations of keywords in paragraphs. Whereas prior ordering methods do not include the combinations, the embodiments discussed hereinbefore do include such combinations thereby providing a superior method of prioritizing documents.

Although the specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the inventive subject matter. It is to be understood that the above description is intended to be illustrative, and not restrictive. Combinations of the above embodiments and other embodiments will be apparent to those of skill in the art upon reviewing the above description. The scope of the inventive subject matter includes any other applications in which the above structures and fabrication methods are used. Accordingly, the scope of the claimed inventive subject matter should only be determined with reference to the appended claims, along with the full scope of equivalences to which such claims are entitled.

What is claimed is:

1. A method comprising:
generating a plurality of keywords from a target text, the generating including excluding one or more word stems from the plurality of keywords;
determining one or more combination counts according to the plurality of keywords; and
prioritizing a plurality of documents according to the one or more combination counts.

2. The method of claim 1, wherein the prioritizing the plurality of documents includes prioritizing according to worth values.

3. The method of claim 1, further comprising receiving a selection of the target text.

4. The method of claim 3, wherein the target text is a patent claim.

5. The method of claim 1, further comprising comparing a target count of one or more keywords in the plurality of keywords to a filter count.

6. The method of claim 1, further comprising:
receiving a selection of a filter keyword from the plurality of keywords; and
filtering a document set to select a plurality of filtered documents that include the filter keyword;
wherein prioritizing the documents prioritizes the filtered documents.

7. A method comprising:
receiving a first document from a document set, the first document including one or more paragraphs;
retrieving a plurality of keywords and determining a plurality of paragraph presences for each of the one or more paragraphs;
determining a combination count for the first document; and
prioritizing the first document within the document set according to the combination count.

8. The method of claim 7, wherein determining the combination count includes calculating the number of distinct combinations of positive paragraph presences.

9. The method of claim 7, further comprising:
marking the first document as retained upon determining the combination count is greater or equal to a combination count threshold; and
prioritizing the first document upon determining it has been marked retained.

10. The method of claim 7, further comprising:
marking the first document as filtered upon determining it matches a filter keyword; and
prioritizing the first document upon determining it has been marked filtered.

11. The method of claim 7, further comprising:
calculating a plurality of document presences for the first document; and
prioritizing the first document according to the plurality of document presences.

12. The method of claim 7, wherein determining the plurality of paragraph presences includes:
determining the presence of one or more keywords in the plurality of keywords with the one or more paragraphs; and
upon determining a first keyword from the plurality of keywords is present in a first paragraph from the one or more paragraphs, marking the combination of the first paragraph and the first keyword as having a positive paragraph presence; and
upon determining the first keyword is not present in the first paragraph, marking the combination of the first paragraph and the first keyword as having a negative paragraph presence.

13. The method of claim 7, wherein calculating the plurality of document presences includes calculating the total number of positive paragraph presences for the one or more paragraphs.

14. A method comprising:
gathering a plurality of keywords from a target text;
calculating a target count and a document count for the plurality of keywords;
calculating a worth for the plurality of keywords according to the target count for the plurality of keywords and the document count for the plurality of keywords; and
ranking the plurality of keywords according to the worth.

15. The method of claim 14 further comprising:
retrieving a selection of excluded word stems; and
removing the selection of excluded word stems from the plurality of keywords.

16. The method of claim 14 wherein the target count is the number of times a keyword appears in the target text.

17. The method of claim 14, wherein the document count is the number of documents in which a keyword is included.

18. A method comprising:
determining one or more paragraph presence counts for a plurality of paragraphs according to a plurality of keywords; and
prioritizing the plurality of paragraphs according to the one or more paragraph presence counts.

19. The method of claim 18, further including:
generating the plurality of keywords from a target text, the generating including excluding one or more word stems from the plurality of keywords;

20. A system comprising:
a generation component to generate a plurality of keywords from a target text, the generating including excluding one or more word stems from the plurality of keywords;
a determination component to determine one or more combination counts; and
a text analysis engine to prioritize the plurality of documents according to the one or more combination counts.

21. A machine-readable medium having executable instructions for performing a method, the method comprising:
generating a plurality of keywords from a target text, the generating including excluding one or more word stems from the plurality of keywords;
determining one or more combination counts; and
prioritizing the plurality of documents according to the one or more combination counts.
